(19) United States
(12) Patent Application Publication
(10) Pub. No.: US 2018/0229556 A1
(43) Pub. Date: Aug. 16, 2018

(54) TIRE WITH RETRACTABLE STUDS

(71) Applicant: Blowfish Traction Inc., Ottawa (CA)

(72) Inventor: Jeff Mierins, Ottawa (CA)

(73) Assignee: Blowfish Traction, Inc., Ottawa (CA)

(21) Appl. No.: 15/889,474

(22) Filed: Feb. 6, 2018

Related U.S. Application Data
(60) Provisional application No. 62/455,336, filed on Feb. 6, 2017.

(51) Int. Cl. B60C 11/16

(52) U.S. Cl. CPC B60C 11/1606

(57) ABSTRACT

The present invention provides a tire with retractable studs. A stud retraction control mechanism can manipulate the protraction or retraction state of a tire stud within the tire. The stud retraction control mechanism may be accessed and controlled by a vehicle user who may decide to retract or protract studs within the tire to suit vehicle use conditions.

### CROSS-REFERENCE TO RELATED APPLICATIONS

This patent application claims priority from, and incorporates by reference the entire disclosure of U.S. Provisional Patent Application No. 62/455,336 filed on Feb. 6, 2017.

### BACKGROUND

The present invention pertains to the field of tires and studs and in particular to a tire with retractable studs.

Studs are used on a wide range of vehicles, and specifically on tires to provide extra traction on a surface. Further traction on a tire may act to improve the control of a vehicle—this is particularly true on slippery surfaces such as ice, snow and slush. When a vehicle user wishes to operate a vehicle upon various surfaces, the use of studs within a tire may act to reduce traction on certain surfaces while improving traction on others. Studs may also act to degrade or ruin vehicle operation surfaces such as pavement that are not designed to withstand the use of studs.

Usually studs are only available preinstalled within a tire, and the studs used are unable to be removed or reinstalled by the tire user. In the instance that studs may be removed or reinstalled, the tire user must take the tire to the original tire provider. Replacing or removing studs can take large amounts of time, and requires the transporting the tire to the retailer for removal.

Studs are generally mounted on a tire by being forced into the treads of a tire. This is often accomplished by applying pressure to a stud, which presses the stud into the tread and then removes the rubber at the location the stud is installed. It is difficult to remove the stud once it has been installed into the tire, and the placement of the stud usually cannot be altered.

Therefore, there is a need for a tire with retractable studs that are easily retracted or protracted from a tire without the need to transport the tire to a stud removal agent. There is a further need for a tire that allows the consumer to use the same tire with or without studs.

This background information is provided to reveal information believed by the Applicant to be of possible relevance to the present invention. No admission is necessarily intended, nor should be construed, that any of the preceding information constitutes prior art against the present invention.

### SUMMARY OF THE INVENTION

An object of the present invention provides a tire with retractable studs. In accordance with an aspect of the present invention, there is provided a tire with retractable studs comprising a tire rim supporting an inner tire and capable of being fixed to a vehicle; an inner tire containing at least one stud retraction control mechanism and supporting an outer tire; a stud retraction control mechanism capable of controlling retraction and protraction of at least one stud; an outer tire containing at least one outer tire recess; an at least outer tire recess capable of sheathing a stud; and at least one stud.

In accordance with another aspect of the present invention, there is provided a tire with retractable studs comprising an inner tire containing at least one stud retraction control mechanism and supporting an outer tire; a stud retraction control mechanism capable of controlling retraction and protraction of at least one stud; an outer tire containing at least one outer tire recess; an at least outer tire recess capable of sheathing a stud; and at least one stud.

### BRIEF DESCRIPTION OF THE FIGURES

A more complete understanding of the embodiments of the present invention may be obtained by reference to the following Detailed Description when taken in conjunction with the accompanying Drawings wherein:

FIG. 1 illustrates a cross-sectional view of the tire without the retractable studs or stud retraction control mechanism;

FIG. 2 illustrates a cross-sectional quarter view of the tire with retractable studs;

FIG. 3 illustrates a cross-sectional view of the tire with retractable studs; and

FIG. 4 illustrates a cross-sectional view of the tire with retractable studs with vehicle user controls for the stud retraction control mechanism.

### DETAILED DESCRIPTION

This invention provides a tire with retractable studs (also referred to as “TRS” herein). The TRS can make use of a tire rim that supports an inner tire—the tire rim is capable of being fixed to a vehicle controlled by a vehicle user (also referred to as “VU” herein). The TRS inner tire can contain at least one stud retraction control mechanism (also referred to as “SRCM” herein), which may also be controlled by a VU. The SRCM controls retraction and protraction of studs within the TRS. The inner tire can support an outer tire that makes direct contact with a driving surface. The outer tire contains at least one outer tire recess (also referred to as “OTR” herein) which sheaths a stud. Studs within the OTRs can be protracted and retracted by a VU controlling the SRCM.

In one embodiment, it is contemplated that the TRS is configured to be used as a tire of a vehicle within the transport, mining, forestry, construction, military, recreational or other industry as would be understood by someone skilled in the art, and on vehicles such as, but not limited to, military vehicles, heavy machinery and equipment, farming machinery and equipment, leisure and recreational vehicles and machinery, utility vehicles, cars, trucks, vans, buses, transport trucks, motorcycles, manually propelled vehicles, all-terrain vehicles, electric vehicles, trailers, snow mobiles, snow and/or ice vehicles, or other vehicles as would be understood by someone skilled in the art.

In one embodiment, it is contemplated that the TRS may be used as one tire, or multiple tires of a vehicle. The TRS may be used to replace a tire or multiple tires designed for a specific surface, season, or environmental condition. It is also contemplated that the TRS design may be manipulated to be applicable to vehicle tracks for use on snowmobiles, military vehicles, other vehicles with tracks or treads, or otherwise as would be understood by someone skilled in the art. The alteration may include, but is not limited to, using an inner and outer track instead of inner and outer tire.

In another embodiment, it is contemplated that the TRS may be used as a new tire. It is also contemplated that a used tire may be retrofitted to become a TRS.

In one embodiment, it is contemplated that the construction of the TRS may be made of separate pieces, assembled into the TRS.

In another embodiment, it is contemplated that components or parts of the TRS may be comprised of different materials, as would be understood by someone skilled in the art.

In one embodiment, it is contemplated that the inner and outer tire portion of the TRS may be made of the same material. It is also contemplated that the inner and outer tire portions may be made of different materials.

In another embodiment, it is contemplated that the inner and outer tires may be made of synthetic rubber, natural rubber, fabric, wire, carbon black, chemical compounds such as polymers, wood, walnut shell, some combination thereof, or some other material as would be understood by someone skilled in the art.

In one embodiment, it is contemplated that the studs may be made of steel, stainless steel, treated steel, aluminum, treated aluminum, copper, treated copper, iron, treated iron, metal, treated metal, alloys, treated alloys, plastic, treated plastics, composite, treated composite, ceramic, treated ceramic, some combination thereof or other material as would be understood by someone skilled in the art.

In one embodiment, it is contemplated that the size of the TRS or specific components of the TRS are varied to suit a specific vehicle or surface condition. For example, a TRS may be made larger overall to better suit heavy machinery. Alternatively, a TRS may be made smaller overall to better suit a small vehicle. Alternatively, an OTR may be made larger to suit a larger stud, which provides greater traction on ice.

In one embodiment, the TRS can be able to monitor how the studs, SRCM, or other TRS component react to specific vehicle or surface conditions. This monitoring could be achieved directly though those components, or by including sensor components that are able to monitor the TRS. Information obtained through this monitoring can optimally be used to inform the functionality of the TRS, real-time driving condition reporting, or otherwise as would be understood by someone skilled in the art.

In another embodiment, when the TRS monitors how the studs, SRCM, or other TRS component react to specific vehicle or surface conditions, the information obtained may be provided to the vehicle user through a personal computing device connected to the internet.

### Stud Retraction Control Mechanism

In one embodiment, the SRCM is able to manipulate the state of a tire stud within the TRS. The SRCM may cause the stud to be protracted, semi-protracted, retracted, semi-retracted, removed, or otherwise as would be understood by someone skilled in the art.

In another embodiment, the SRMC manipulation of the state of a tire stud may be aided by a secondary component such as, but not limited to, a functioning means such as a spring, piston, valve, attachment, elastic, coil, cover, screw, fastener, or otherwise as would be understood by someone skilled in the art.

In one embodiment, the SRCM may be manually controlled by the VU using a control mechanism as would be understood by someone skilled in the art. For example, the VU may be able to select whether or not they wish to have the studs protracted using a button located within the vehicle. As another example, the VU may make a touch screen selection on a vehicle user interface to control the SRMC.

In another embodiment, the SRMC may be automatically controlled. The VU may select automatic SRMC control within the vehicle user interface selections. Once this state has been selected the TRS can monitor driving conditions such as, but not limited to, vehicle operating surface traction, speed, friction, vehicle operating surface material, weather conditions, or other factors as would be understood by someone skilled in the art. For example, the TRS may monitor traction conditions on the vehicle operating surface, and may automatically protract the studs once icy road conditions are observed.

In one embodiment, the SRMC may be able to control the air pressure between the inner and outer tire. The studs may be set within OTRs using a retracting load force. When the SRMC is engaged (either by a VU manually, or automatically) it may inflate the air pressure within the TRS, which correspondingly protracts the studs pushing them out through the OTRs. When the SRMC is reengaged to retract the studs, it may decrease the air pressure and the studs can retract back into the OTRs.

In another embodiment, the SRMC can have the ability to control the air pressure using a centralized tire inflation system.

In another embodiment, the SRMC can control the pressure between the inner and outer tire using an alternative tire cavity medium such as, but not limited to, gases other than air, liquids, or otherwise as would be understood by someone skilled in the art.

In one embodiment, the SRMC can be able to control an electric charge through the TRS. Studs may be set and operated within OTRs through induction of an electrical charge. When engaged to protract studs the SRMC may send electrical charge through the rim of the tire to the studs. Once the charge reaches the studs they can protract through the OTRs and remain protracted until the electrical charge is removed. When the SRMC stops sending an electrical charge to the studs, the studs can retract. This retraction and protraction control through electric charge may also be applied in the reverse—a continuous charge can keep the studs in a retracted position, and removing the charge can cause the studs to protract.

In another embodiment, the SRMC manipulation of studs through control of an electric charge can be aided by a piston or spring. The piston or spring may be extended when an electrical charge passes through it, which in turn can protract the stud. When the electrical charge is halted, the piston or spring can withdraw, which in turn can retract the stud.

In another embodiment, various types of studs, for example those made of pure metal or those made of alloys, can be activated by the SRMC independently from each other within the TRS. The studs may also be activated in an additive contact as vehicle surface conditions require additional studs. In one example, variability in electric charge through the TRS can protract or retract additional studs.

In one embodiment, the SRMC may manipulate a traction aid other than a stud. For example the SRMC may be able to retract or protract a grouser on a tank in order to meet specific driving surface conditions. Manipulation of the traction aid may be achieved by the SRMC controlling the traction aid directly, or by the SRMC controlling protraction or retraction of studs, which in turn manipulate an additional traction aid.

### Inner and Outer Tires

In one embodiment, the inner tire can contain a SRCM and can support the outer tire.

In one embodiment, the outer tire can contain OTRs. The outer tire outer surface can make contact with a vehicle operating surface in order to propel the vehicle.

In one embodiment, the TRS may be positioned alongside additional TRSs or conventional tires in order to enable functionality of the TRS, or to increase traction on a vehicle operating surface.

In another embodiment, a TRS may be positioned in between two other tires. The SRCM may utilize this configuration in order to control the studs. The SRCM may mechanically compress the outer tires together putting additional pressure on the TRS, until this pressure acts to protract the studs out through the OTRs. The SRMC may also extend the outer tires away from the central TRS in order to reduce pressure on the TRS acting to retract the studs back into the OTRs. It is also contemplated that two or more TRSs may be compacted in the same way in order to protract or retract the studs.

In another embodiment, a centrally positioned TRS may be compacted by additional tires being compressed into the TRS using air pressure. The SRCM may act to inflate the additional exterior tires, applying pressure upon the central TRS. This pressure may act to protract the studs out of the OTRs. If the SRCM reduces the air pressure of exterior tries, pressure can be reduced upon the centralized TRS and studs may be retracted back into the OTRs.

### Studs

It is contemplated that the studs may be configured to alter traction of the TRS on a vehicle operating surface. The studs may be such protrusions such as a spike, screw, point, rod, prism, nodule, fork, or otherwise as would be understood by someone skilled in the art. The stud may be straight, curved, broaden, flare, narrow, or otherwise as would be understood by someone skilled in the art. The studs may be protruded above the tread of the outer tire, or be embedded within the tread for more subtle traction changes.

In one embodiment, the studs may be placed in specific configurations to alter traction of the TRS on a vehicle operating surface as would be understood by someone skilled in the art.

In one embodiment, the studs may be able to protract or retract from within the tire recess at variable lengths. The studs may not have to protract or retract fully, but may be manipulated by the SRMC to protract or retract partially to better suit environmental conditions. Each stud may be protracted or retracted to the same length, or each stud may be protracted or retracted to different lengths.

In one embodiment, studs within the TRS may be configured to utilize different properties from one another to better suit a specific vehicle surface, or environmental condition. For example, studs may be made of different materials or a different shape. The SRMC may manipulate specific studs within the TRS to retract or protract to meet various environmental or driving surface conditions. For example, the SRMC may cause spike studs made of steel, and rounded nubs made of rubber, both within the same TRS to protract or retract differently. When icy conditions are detected upon the driving surface, the spike studs may be protracted while the rounded nubs are retracted. Alternatively the SRMC may cause the rounded numbs to protract, and the spike nubs to retract when the driving surface conditions are found to be compacted dirt. It is also contemplated that more than one type of stud could be retracted or protracted together.

In another embodiment, the studs may provide additional traction control through the administration of an additional traction aid. For example, the studs may be able to administer deicing fluid to be released upon the vehicle driving surface through the studs when the vehicle is stuck in snow. Administration of the traction aid may be directed by the SRMC.

### Outer Tire Recess

In one embodiment, the OTRs may be configured to sheath a stud. The OTRs may be specifically suited to suit a specific stud, or may be generic to allow for sheathing capabilities of many different stud shapes and sizes.

In another embodiment, the OTRs may consist of cut outs within the outer tire capable of sheathing a stud. The OTRs may run through the entirety of the width of the outer tire, or may run through a portion of the outer tire.

In another embodiment, the OTRs may be lined by an additional material to alter frictional properties between the stud and the surface of the OTR.

### Examples

The invention will now be described with reference to specific examples. It will be understood that the following examples are intended to describe embodiments of the invention and are not intended to limit the invention in any way.

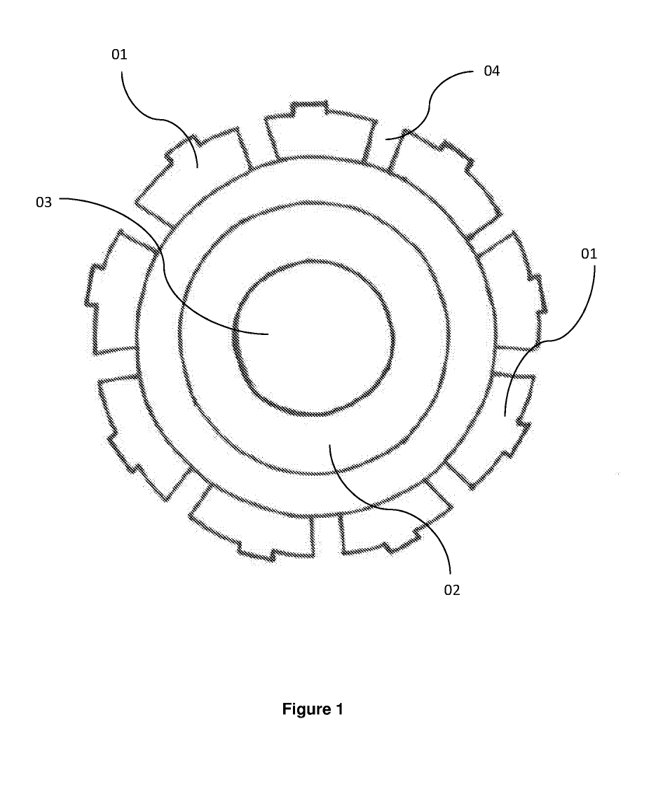

In one example as illustrated in FIG. 1, the TRS is shown without the inclusion of the SRCM or the studs. The most interior portion of the TRS is the tire rim 03, which supports the inner tire 02. The inner tire 02 supports the outer tire 01, which contains outer tire recess' 04.

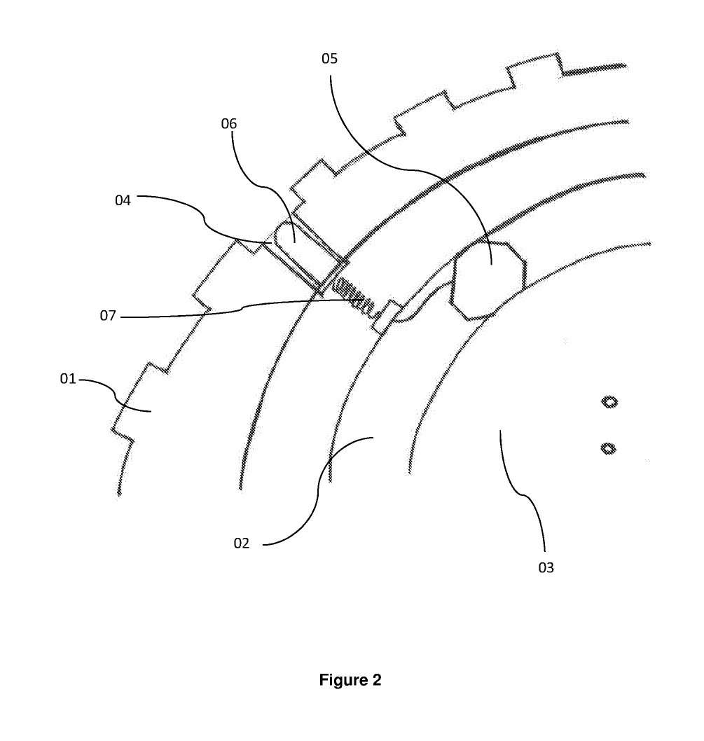

In another example as illustrated in FIG. 2, a cross-sectional view of the upper quarter of the TRS is shown. The tire rim 03 supports the inner tire 02, which in turn supports the outer tire 01. Contained within the OTR 04 is a stud 06, which is controlled by the stud retraction control mechanism 05 which is contained within the inner tire 02. A secondary component 07 is also used to help the SRCM 05 control the studs within the tire.

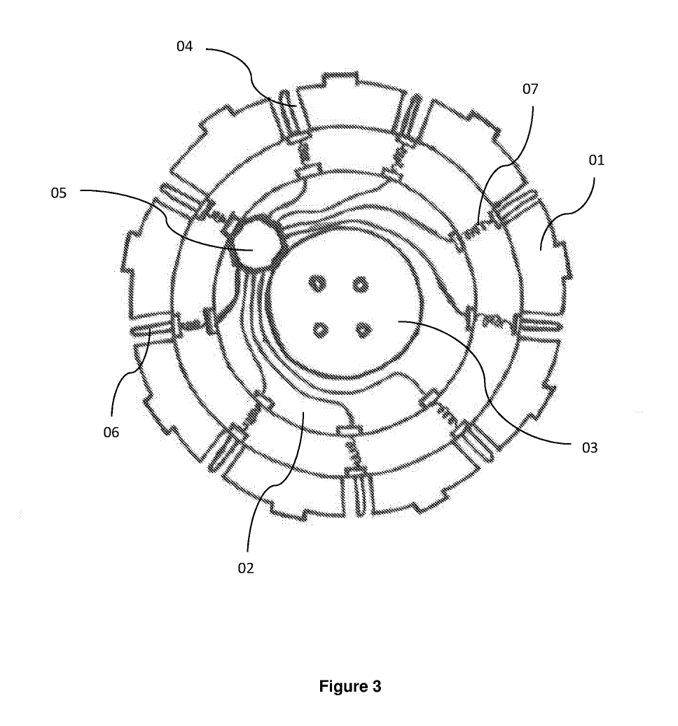

In another example as illustrated in FIG. 3, a cross-sectional view of the Full TRS is shown. The tire rim 03 supports the inner tire 02, which contains a stud retraction control mechanism 05. The SRCM 05 utilizes a secondary component 07 to control the studs 06 sheathed within the OTRs 04. The outer tire 01 will make direct contact with the vehicle operation surface in order to propel the vehicle.

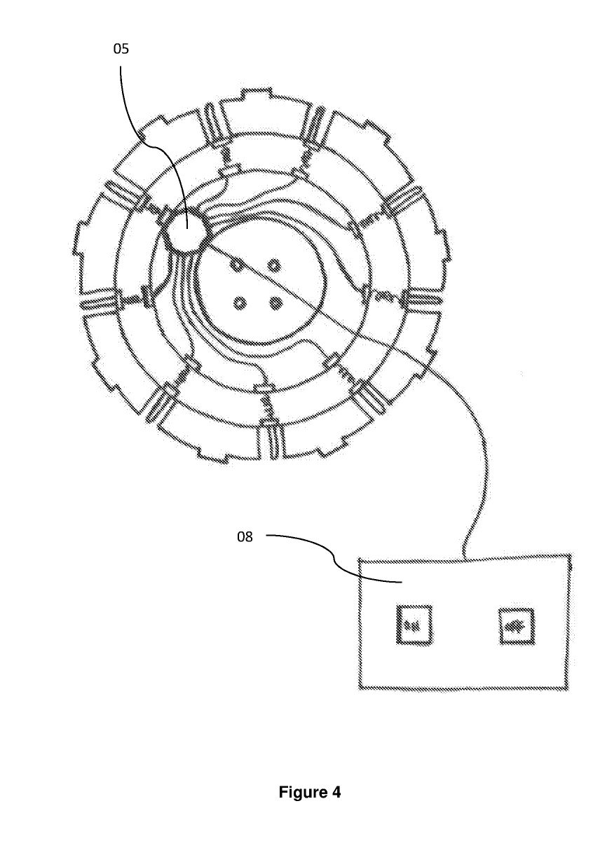

In another example as illustrated in FIG. 4, a cross-sectional view of the full TRS is shown. A vehicle user will have the ability to control the SRCM 05 through a vehicle user control mechanism 08.

Although various embodiments of the system of the present disclosure have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

Furthermore, the scope of the claims should not be limited by the preferred embodiments set forth in the examples, but should be given the broadest interpretation consistent with the description as a whole.

What is claimed is:

1. A tire with retractable studs comprising:
a tire rim supporting an inner tire and capable of being fixed to a vehicle;
an inner tire containing at least one stud retraction control mechanism and supporting an outer tire;
a stud retraction control mechanism capable of controlling retraction and protraction of at least one stud;
an outer tire containing at least one outer tire recess;
an at least outer tire recess capable of sheathing a stud; and
at least one stud.

2. The tire with retractable studs of claim 1, wherein the at least one stud retraction control mechanism may be controlled by a vehicle user.

3. The tire with retractable studs of claim 1, wherein the at least one stud retraction control mechanism is able to manipulate protraction or retraction state of a tire stud within the tire.

4. The tire with retractable studs of claim 1, wherein the at least one stud retraction control mechanism is able to manipulate other functionality of the tire with retractable studs.

5. A tire with retractable studs comprising:
an inner tire containing at least one stud retraction control mechanism and supporting an outer tire;
a stud retraction control mechanism capable of controlling retraction and protraction of at least one stud;
an outer tire containing at least one outer tire recess;
an at least outer tire recess capable of sheathing a stud; and
at least one stud.
